(19) United States
(12) Patent Application Publication
(10) Pub. No.: US 2020/0047398 A1
(43) Pub. Date: Feb. 13, 2020

(54) SHEET LAMINATE AND PRODUCTION METHOD FOR SHEET LAMINATE

(71) Applicant: 3M INNOVATIVE PROPERTIES COMPANY, St. Paul, MN (US)

(72) Inventor: Ken Egashira, Chigasaki (JP)

(21) Appl. No.: 16/499,628

(22) PCT Filed: Mar. 26, 2018
(86) PCT No.: PCT/IB2018/052056

§ 371 Date: Sep. 30, 2019

(30) Foreign Application Priority Data
Apr. 7, 2017 (JP) 2017-077009

(51) Int. Cl. B29C 63/04; B29C 63/00; B29C 53/34; B29C 53/84; B32B 27/36; B32B 27/40; B32B 7/022

(52) U.S. Cl. CPC B29C 63/04; B29C 63/0017; B29C 63/0065; B29C 53/34; B29L 2031/3005; B32B 27/365; B32B 27/40; B32B 7/022; B29C 53/84

(57) ABSTRACT

A sheet laminate that can be easily affixed to a bonded surface and which can enhance handleability. The sheet laminate (1) includes a pair of sidewall parts (3), each extending toward the rear surface (2b) side from a pair of mutually opposing edges of the main body part (2). The pair of sidewall parts 3 have a curved shape projecting outward with respect to the main body part (2). Including such a sidewall part (3) makes it possible to affix the sheet laminate (1) to the B-pillar (50) by sandwiching the side surfaces (50b) of both sides of the B-pillar (50) having a bonded surface (50a) by using the curved shape of the pair of sidewall parts (3) while covering the bonded surface (50a) with the design surface of the main body part (2). As a result, the sheet laminate (1) can be affixed easily to the bonded surface (50a), which enhances handleability of the sheet laminate (1).

### TECHNICAL FIELD

The present disclosure relates to a sheet laminate used to decorate a surface of an object by affixing the sheet laminate to a bonded surface of various objects such as vehicle parts, and a production method for a sheet laminate.

### BACKGROUND ART

Various products have been proposed as sheet laminates to be affixed to the bonded surface of an object. For example, an extensible film provided with a pressure-sensitive adhesive layer on the back side is described in JP 2002-544364 T as a sheet laminate used to ornament vehicle parts. This sheet laminate is affixed to a bonded surface of an object while the extensible film is aligned via an adhesive. In addition, JP 2010-111157 A describes a resin garnish to be affixed to an object such as a door frame for a vehicle. This is affixed to the bonded surface of the door frame by a joining means such as double-sided adhesive tape provided at the end.

### SUMMARY OF THE INVENTION

The extensible film described in JP 2002-544364 T is thin and easily wrinkled, and it sags under its own weight. Therefore, when affixed to an object, it is necessary to align the film end face with the bonded surface, partially fix the film end face, and then affix the extensible film while stretching the extensible film. Therefore, the affixing operation is troublesome. In addition, due to the thinness of an extensible film, concavities and convexities reflecting concavities and convexities caused by defects or contamination of the bonded surface of the object are reflected in the film surface after affixing, which may cause problems with the appearance.

On the other hand, the garnish described in JP 2010-111157 A is a rigid body which ordinarily does not deform when attached to an object, and thus the operation of affixing the garnish to an extensible film is easy, and minute concavities and convexities in the bonded surface of the object do not affect the appearance after affixing. However, since such garnishes are ordinarily formed by injection molding or the like, production is burdened by a need to prepare a mold in accordance with the shape of each bonded surface. In addition, since the garnish is a rigid body having at least a certain thickness, the garnish is heavy, and there is a demand for a reduction in weight. Further, since the garnish is thick, a height difference arises in comparison to the window glass of an adjacent door when affixed to a door frame. The garnish therefore bulges out, which affects the appearance.

The sheet laminate according to one aspect of the present disclosure is a sheet laminate to be affixed to a bonded surface of an object, the sheet laminate including: a main body part including a front surface serving as a design surface and a rear surface; and a pair of sidewall parts, each extending toward the rear surface side from a pair of mutually opposing edges of the main body part; wherein the pair of sidewall parts have a curved shape protruding outward with respect to the main body part.

In the sheet laminate according to one aspect of the present disclosure, the sheet laminate includes a pair of sidewall parts, each extending toward the rear surface side from a pair of mutually opposing edges of the main body part. The pair of sidewall parts have a curved shape projecting outward with respect to the main body part. Including such a sidewall part makes it possible to affix the sheet laminate to an object by sandwiching the side surfaces of both sides of an object having a bonded surface using the curved shape of the pair of sidewall parts while covering the bonded surface with the design surface of the main body part. As a result, the sheet laminate can be affixed easily, which enhances handleability.

The thickness of the main body part may be from 0.3 to 2 mm. As a result, both the mountability of the sheet laminate onto an object and delamination resistance after mounting can be achieved.

The main body part may include a polycarbonate layer. As a result, a main body part which has both flexibility and rigidity can be formed. In addition, the sidewall parts become easy to fold.

The main body part may include a polyurethane layer as a surface protecting layer. As a result, the sidewall parts become easy to fold.

The rear surface may have a higher roughness than the front surface. As a result, when the sheet laminate is mounted on an object, the sliding of the rear surface with respect to the bonded surface can be improved, which enhances mountability.

The depth dimensions of the curved shape of the pair of sidewall parts may be asymmetrical. As a result, the pair of sidewall parts respectively have depth dimensions corresponding to the shape of the object.

The sidewall parts have a first region on the upper end side and a second region below the first region. In the first region, the depth dimension of the curved shape along one edge may be shorter than the depth dimension of the curved shape in the second region. For example, when a structure such as a sash extending in the lateral direction is provided near the upper end of the object, the sidewall parts become difficult to fit into the side surfaces of the object due to interference between the structure and the sidewall parts near the structure. Disposing the first region having a short depth dimension near the structure makes it possible to easily fit the sidewall parts into the side surfaces of the object by pressing the vicinity of the first region into the object.

The production method for a sheet laminate according to one aspect of the present disclosure is a production method for a sheet laminate to be affixed to a bonded surface of an object, the production method including: preparing a sheet member including a front surface serving as a design surface and a rear surface; and a folding step of folding the ends on both sides of the sheet member to form a pair of sidewall parts extending toward a rear surface side with respect to a main body part; wherein in the folding step, the ends of the sheet member are folded with a mold, and heat is applied to the folded portions to form sidewall parts having a curved shape projecting outward with respect to the main body part.

With the production method for a sheet laminate according to one aspect of the present disclosure, a sheet laminate exhibiting the same operation and effect as the sheet laminate described above can be produced.

According to one aspect of the present invention, the sheet laminate can be affixed easily, which enhances handleability.

### BRIEF DESCRIPTION OF THE DRAWINGS

FIG. 1 is a front view of a sheet laminate according to an embodiment.

FIG. 2A is a cross-sectional view along line IIa-IIa illustrated in FIG. 1.

FIG. 2B is a cross-sectional view along line IIb-IIb illustrated in FIG. 1.

FIG. 3 is a drawing illustrating the vicinity of the upper end part of the sheet laminate when viewed from the back surface side.

FIG. 4 is a drawing illustrating a B-pillar to which the sheet laminate of the embodiment is affixed.

FIG. 5 is a schematic cross-sectional view along line V-V illustrated in FIG. 4.

FIGS. 6A and 6B are drawings for describing the method of affixing the sheet laminate.

FIG. 7 is a series of schematic diagrams illustrating the folding step for forming sidewall parts.

FIG. 8A is a schematic plan view of a sheet laminate according to a modified example.

FIG. 8B is a schematic cross-sectional view along line VIIIb-VIIIb illustrated in FIG. 8A.

FIG. 8C is a schematic cross-sectional view along line VIIIc-VIIIc illustrated in FIG. 8A.

FIG. 9 is a table illustrating the compositions of polyurethane solutions used in the examples.

FIG. 10 is a table showing the test conditions and results for each example.

FIGS. 11A and 11B are tables showing the test conditions and results for each example.

FIG. 12 is a table showing the test conditions and results for each example.

FIG. 13 is a table showing the test conditions and results for each example.

### DESCRIPTION OF THE PREFERRED EMBODIMENTS

The sheet laminate according to one embodiment of the present disclosure is provided with a design surface and can be affixed to a bonded surface of various objects to decorate the objects with the design surface. The types of objects to be decorated are not limited, and representative examples include vehicle parts, electrical parts, and architectural parts.

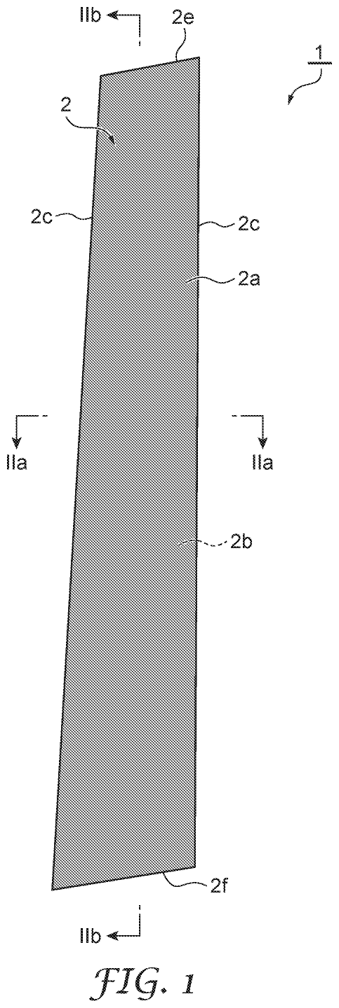

The sheet laminate and the production method for the sheet laminate according to one embodiment of the present disclosure include a main body part including a front surface serving as a design surface and a rear surface, and a pair of sidewall parts, each extending toward the rear surface side from a pair of mutually opposing edges of the main body part. The pair of sidewall parts have a curved shape projecting outward with respect to the main body part. The main body part can be deformed in conformance with the shape of the bonded surface and can be mounted and fixed to the bonded surface with substantially no extension at the time of affixing. A specific structural example will be described below, but the sheet laminate of this embodiment is typically a sheet laminate 1 as illustrated in FIGS. 1 to 3 to be affixed to an automobile part such as a door frame part or a window frame part.

Detailed descriptions of the embodiments according to the present disclosure are given below with reference to the attached drawings. Note that, in the descriptions of the drawings, the same reference symbols are assigned to elements that are the same or equivalent, and that redundant descriptions thereof are omitted.

A sheet laminate according an embodiment of the present disclosure is a member to be affixed to a bonded surface of any object. The sheet laminate includes a design surface formed on the bonded surface side of the object to which the sheet laminate is affixed. The object to which the sheet laminate is to be affixed may be any object that requires the formation of a design surface. For example, the sheet laminate may be affixed to an automobile part or the like as an object. In addition, the sheet laminate may be affixed to a vehicle door frame part as an object. Examples of vehicle door frame parts include an A-pillar (front pillar) or a C-pillar (rear pillar) of an automobile. In addition, the sheet laminate may be affixed to a vehicle window frame part as an object. An example of a vehicle window frame part is a B-pillar (central pillar in the forward/backward direction of the vehicle).

### Structure of the Sheet Laminate

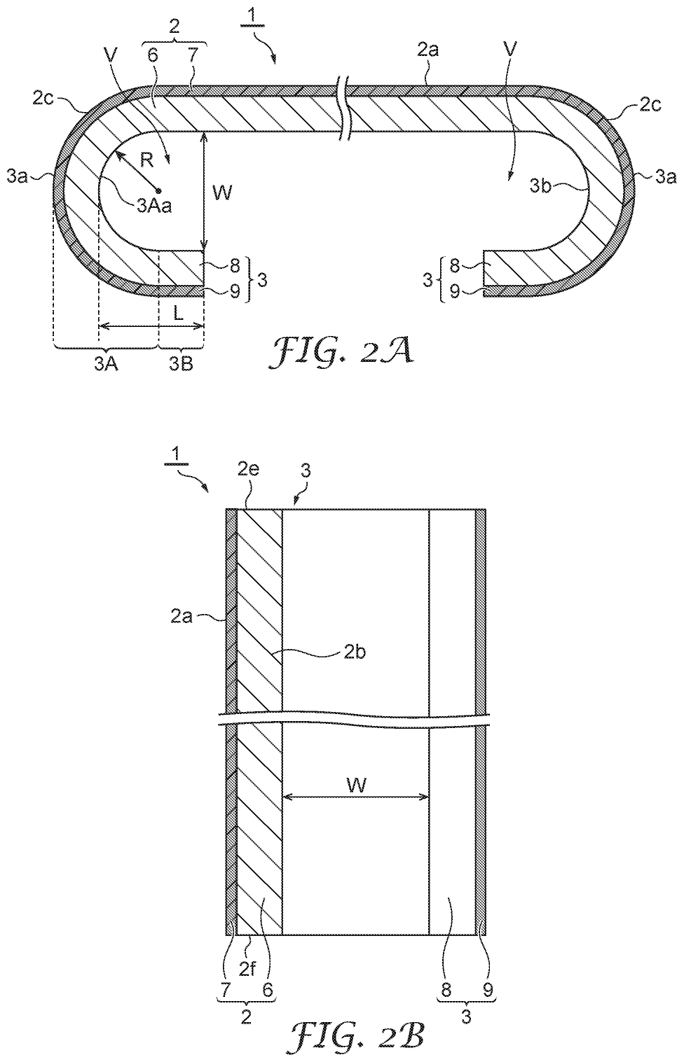

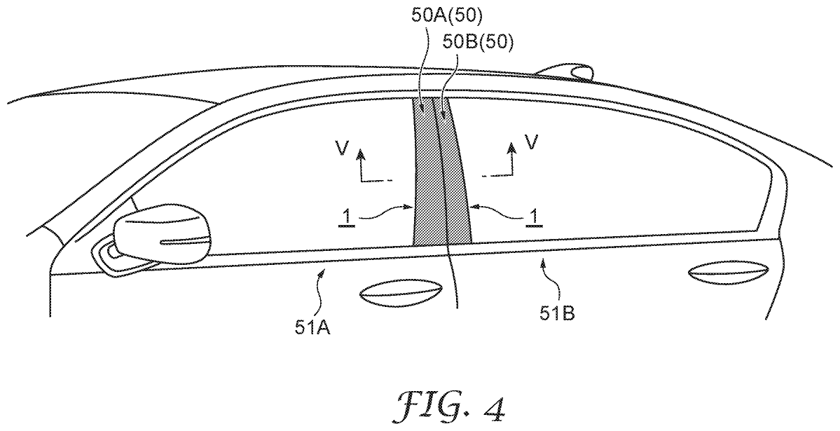

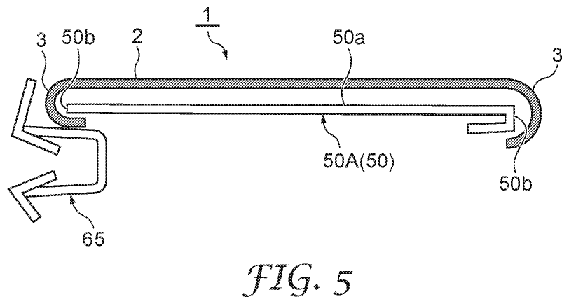

In the embodiment illustrated in FIGS. 1 to 5, a description is given using a case in which the sheet laminate is a cover member to be affixed to a B-pillar 50 as an automobile door frame part as an example. The B-pillar 50 includes a B-pillar 50A provided on a front door 51A and a B-pillar 50B provided on a rear door 51B (see FIG. 4). A window glass of the front door 51A is positioned on the left side of the B-pillar 50A, and a window glass of the rear door 51B is positioned on the left side of the B-pillar 50B. The surface of the B-pillar 50 on the outside of the vehicle is formed as a bonded surface 50a (see FIG. 5). The bonded surface 50a extends in the vertical direction and curves slightly and forms a convexity facing the outside of the vehicle. As illustrated in FIGS. 1 and 2, the sheet laminate 1 includes a main body part 2 and sidewall parts 3.

The main body part 2 includes a front surface 2a serving as a design surface and a rear surface 2b. The main body part 2 has a shape which covers at least a part of the bonded surface 50a of the B-pillar of the vehicle in a plan view. In this embodiment, the main body part 2 has a shape which covers substantially the entire bonded surface 50a of the B-pillar. Specifically, the main body part 2 extends along a first direction (vertical direction on the page illustrated in FIG. 1) and assumes a band shape. The main body part 2 includes a pair of edges 2c which extend in the longitudinal direction (first direction) and oppose one another. In addition, the main body part 2 includes a pair of edges 2e and 2f which extend in the lateral direction and oppose one another. Note that the lateral direction may also be called the “width direction”. The pair of edges 2c of the main body part 2 extend in an inclining manner such that the distance therebetween increases as the edges 2c move from the edge 2e on the upper end side toward the edge 2f on the lower end side. However, the shape of the main body part 2 may be changed appropriately in accordance with the shape of the bonded surface 50a. Note that a “design surface” refers to a surface that has been given various designs to decorate an object. The design differs depending on the application of the object to which the sheet laminate is affixed. Examples of representative designs include patterns of black or other single colors, transparent or multiple colors, characters, and graphics. In addition, the surface may be given a pattern with minute concavities and convexities such as an embossed pattern.

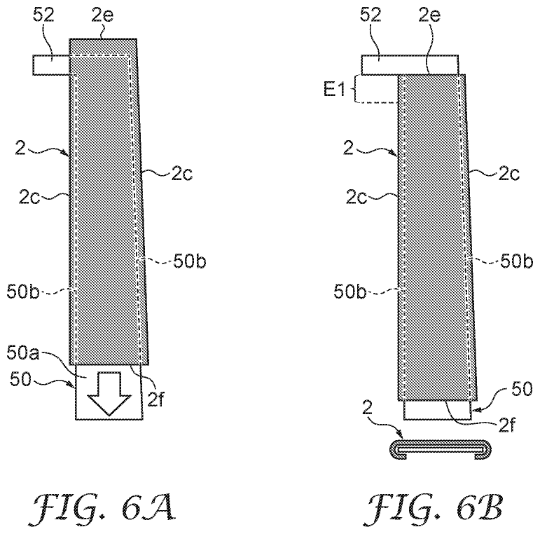

The main body part 2 has a trapezoidal shape when viewed from the front (state illustrated in FIG. 1). Specifically, the width dimension of the main body part 2 (dimension in the horizontal direction between one edge 2c and the other edge 2c) is formed widening from the upper end side toward the lower end side. As a result, as described in FIGS. 6A and 6B below, the sheet laminate 1 can be affixed to the B-pillar 50 by sandwiching the side surface 50b on the upper end side of the B-pillar 50 with the sidewall part 3 on the lower end side of the sheet laminate 1 and sliding the sheet laminate 1 downward in this state.

The main body part 2 can be deformed in accordance with the shape of the bonded surface 50a and undergoes substantially no extension. To be “deformed in accordance with the shape of the bonded surface” means that, when the bonded surface is curved, the main body part is deformed along the surface while conforming to the curved surface. The directionality of the curvature of the bonded surface is not limited, but in the case of a bonded surface of a door frame part, for example, it typically has a curved surface with a radius of from 500 mm to 2000 mm in the longitudinal direction. “Substantially no extension at the time of affixing” means that the original length or width of the main body part does not change under an ordinary force applied to the sheet laminate when an operator affixes the sheet laminate. For example, even when a force of approximately 50 mN to 2.5 N is applied to the sheet laminate at the time of the affixing operation, no extension due to elastic or inelastic deformation occurs.

The sidewall parts 3 respectively extend toward the rear surface side from the mutually opposing edges of the main body part 2. The sidewall parts 3 have a curved shape projecting outward with respect to the main body part 2. In this embodiment, the sidewall parts 3 extend from each of the edges 2c of the main body part 2. The cross-sectional shape of the sidewall parts 3 is substantially a U-shape. In this U-shape, the curved part 3A which curves to form a convexity serves as a convexity facing outward in the width direction of the main body part 2. In addition, the tip part 3B of each sidewall part 3 extends from the tip of the curved part 3A in a straight line toward the inside in the width direction. Note that the entire sidewall part 3 may be curved without the tip part 3B extending in a straight line being formed. A gap V is formed between the main body part 2 and the tip of the curved part 3A and the tip part 3B. The B-pillar 50 is disposed in the gap V. Therefore, the tip of the curved part 3A and the tip part 3B sandwich the B-pillar 50 against the main body part 2. In addition, the base 3Aa on the inner peripheral side of the curved part 3A has a function of regulating the movement of the sheet laminate 1 in the width direction with respect to the B-pillar 50. The sidewall parts 3 have a front surface 3a on the outer peripheral side of the main body part 2 and have a rear surface 3b on the inner peripheral side of the main body part 2. The sidewall parts 3 have a shape which conforms to one edge of the bonded surface 50a and covers at least a part of the side surface 50b of the one edge when the main body part 2 is affixed to the bonded surface 50a of the B-pillar 50 (see FIG. 5). The one edge of the bonded surface 50a and the side surface 50b extend along the longitudinal direction of the B-pillar 50B.

Here, the dimensions of each portion of the sidewall parts 3 are adjusted appropriately in accordance with the shape or thickness of the B-pillar 50 to which the sheet laminate is affixed. As illustrated in FIG. 2, the radius of curvature R of the inner peripheral surface of the curved part 3A may be set to 0.5 to 3 mm or 1 to 1.5 mm, for example. The width dimension W of the gap V may be set to 1 to 6 mm or 2 to 3 mm. The depth dimension L between the tip of the tip part 3B (tip of the curved part 3A in the case where there is no tip part 3B) and the deepest portion of the base 3Aa of the curved part 3A may be set to 1 to 15 mm or 2 to 6 mm. In addition, the depth dimension L of the curved shape of the pair of sidewall parts 3 may be asymmetrical on the left and right sides in FIG. 2. In particular, the depth dimension L on the glass side with respect to the B-pillar 50 (the left side in FIG. 4 in the case of a sheet laminate to be attached to the B-pillar 50A in FIG. 4, for example) may be shallower than on the opposite side (similarly, the right side in FIG. 4) and may be from 3.5 to 5 mm.

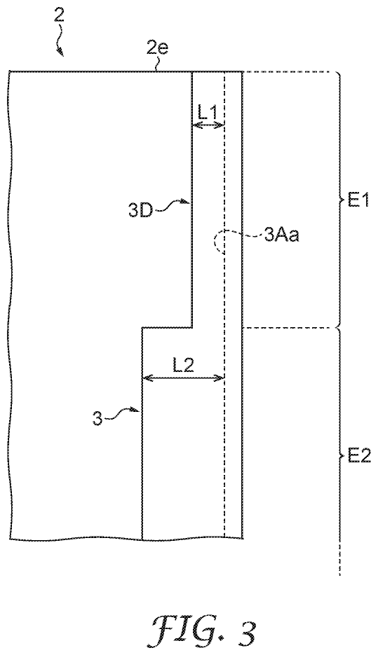

As illustrated in FIG. 3, in this embodiment, the sidewall parts 3 may have a first region E1 on the upper end side and a second region E2 below the first region E1. In the first region E1, the depth dimension L1 of the curved shape of one edge is shorter than the depth dimension L2 of the curved shape of the second region E2. Thus, a portion 3D having the short depth dimension L1 is provided at a position corresponding to the side surface 50b on the side on which a sash 52 is provided (glass side) on the side surface 50b of the B-pillar 50.

In this embodiment, the sidewall parts 3 are formed along roughly the entire edges 2c of the main body part 2, but the sidewall parts 3 are not necessarily formed near the upper end or near the lower end. In addition, the amount that the sidewall parts 3 project from the main body part 2 is not limited as long as the sheet can be affixed to the pillar 50 without interfering with other parts. For example, as illustrated in FIG. 5, the vicinity of the front end of the B-pillar 50A is protected by the sidewall parts 3 of the sheet laminate 1 and a part of a weather strip 65 which houses and seals the glass. The vicinity of the rear end of the B-pillar 50A is protected by the sidewall parts 3 of the sheet laminate 1.

### Layer Structure of the Sheet Laminate

Next, the layer structure of the sheet laminate 1 will be described. The main body part 2 includes a base layer 6 and a surface protecting layer 7 laminated on the base layer 6. The surface protecting layer 7 covers substantially the entire surface of the base layer 6. The surface protecting layer 7 includes a front surface 2a serving as a design surface and a rear surface 2b. The sidewall parts 3 include a base layer 8 and a surface protecting layer 9 laminated on the base layer 8. The surface protecting layer 9 covers substantially the entire surface of the base layer 8. The surface protecting layer 9 includes a front surface 3a serving as a design surface and a rear surface 3b. There may be peelable application film layers on the front surface sides of the surface protecting layers 7 and 9. The base layers 6 and 8 may have peelable liner film layers on the rear surface sides. A printed pattern or logo, a coating of the automobile paint color, a design layer formed by metal deposition to recreate the external appearance of metal, a base layer for forming a design layer, a joining layer for reinforcing the adhesion between layers, or the like may be provided between the base layers 6 and 8 and the surface protecting layers 7 and 9.

A sheet member in which the base layer and the surface protecting layer are formed integrally is used for the main body part 2 and the sidewall parts 3. The sidewall parts 3 may be formed by folding the ends of the sheet member. In this case, the base layer 6 of the main body part 2 and the base layer 8 of the sidewall part 3 are formed integrally as a continuous layer. In addition, the surface protecting layer 7 of the main body part 2 and the surface protecting layer 9 of the sidewall part 3 are formed integrally as a continuous layer. Therefore, in this embodiment, the base layer 6 of the main body part 2 and the base layer 8 of the sidewall part 3 are formed from the same material. The surface protecting layer 7 of the main body part 2 and the surface protecting layer 9 of the sidewall part 3 are made of the same material. However, the base layer 6 of the main body part 2 and the base layer 8 of the sidewall part 3 may be made of different materials. The surface protecting layer 7 of the main body part 2 and the surface protecting layer 9 of the sidewall part 3 may be made of different materials.

### Various Characteristics of the Sheet Laminate

The main body part 2 deforms in accordance with the shape of the bonded surface 50a and can be fixed to the bonded surface 50a by sandwiching the side surface 50b with the sidewall parts 3 with substantially no inelastic deformation.

The main body part 2 deforms in conformance with the shape of the bonded surface 50a when the sheet laminate 1 is affixed to the bonded surface 50a. In this embodiment, the main body part 2 extends along the longitudinal direction (first direction) and can curve in the longitudinal direction. In this case, the operator can easily bend the main body part 2 in conformance with the curved shape of the bonded surface 50a without applying an excessive pressing force to the sheet laminate 1. Note that in this specification, when it is described that the main body part 2 (or the sheet laminate 1) “bends” or “curves”, this means that the front surface 2a and the rear surface 2b bend so as to be rounded.

For example, the bending rigidity of the sheet laminate 1 may be from 0.1 to 23 N, from 0.2 to 23 N, or from 0.8 to 10 N. The “bending rigidity” described here is defined as the maximum load measured by projecting the sheet laminate by a prescribed length in the longitudinal direction, fixing the base thereof, and bending the tip part in a direction perpendicular to the main plane in accordance with the Bending Repulsion Method A of JIS L-1096. When the width exceeds 25 mm, the value can be determined by finding the weighted average with each width for a value measured after dividing the sample in the width direction so that the width is not greater than 25 mm. Since the sheet laminate 1 has this bending rigidity, the main body part 2 deforms in conformance with the shape of the bonded surface 50a and can assume a fixed state on the bonded surface 50a. However, the bending rigidity of the sheet laminate 1 is not limited to the range described above. The 2% tensile strength of the sheet laminate 1 may be not less than 20 N/10 mm of width, not less than 40 N/10 mm of width, not less than 60 N/10 mm of width, or not less than 80 N/10 mm of width. The “tensile strength” described here is defined as the load when the sheet laminate is cut to a width of 10 mm along the longitudinal direction, grasped by a tensile tester, and extended at intervals of 50 mm and a rate of 300 mm/min. Since the sheet laminate 1 has the tensile strength described above, the main body part 2 can assume a state with substantially no stretching deformation. However, the 2% stretching tensile strength of the sheet laminate 1 is not limited to the range described above.

To ensure that the bending rigidity and the tensile strength of the sheet laminate 1 satisfy the conditions described above, the material of the base layer 6 of the main body part 2 and the base layer 8 of the sidewall parts 3 may be a polycarbonate, and the material of the surface protecting layer 7 of the main body part 2 and the surface protecting layer 9 of the sidewall parts 3 may be a polyurethane. In addition, the thickness of the main body part 2 may be from 0.2 mm to 2 mm. More preferably , the thickness of the main body part 2 may be not less than 0.3 mm. Even more preferably, the thickness of the main body part 2 may be not less than 0.5 mm. The thickness of the main body part 2 may be not greater than 1.5 mm. The thickness of the sidewall parts 3 may be from 0.2 mm to 2 mm. More preferably, the thickness of the sidewall parts 3 may be not less than 0.3 mm. Even more preferably, the thickness of the sidewall parts 3 may be not less than 0.5 mm. The thickness of the sidewall parts 3 may be not greater than 1.5 mm. More specifically, the thickness of the base layer 6 of the main body part 2 may be from 0.2 to 2 mm, preferably from 0.3 to 2 mm, and more preferably from 0.5 to 1.5 mm. The thickness of the surface protecting layer 7 of the main body part 2 may be from 0.003 to 0.2 mm and preferably from 0.01 to 0.1 mm. The thickness of the base layer 8 of the sidewall parts 3 may be from 0.2 to 2 mm, preferably from 0.3 to 2 mm, and more preferably from 0.5 to 1.5 mm. The thickness of the surface protecting layer 9 of the sidewall parts 3 may be from 0.003 to 0.2 mm and preferably from 0.01 to 0.1 mm. However, the material, dimensions, or the like of each constituent element may be varied in any manner as long as the bending rigidity and the tensile strength of the sheet laminate 1 satisfy the conditions described above. The conditions described in this paragraph are not conditions essential to the sheet laminate 1, and these conditions need not be satisfied.

The main body part 2 may include a resin layer having a glass transition temperature of not lower than 130° C. At least the base layers 6 and 8 of the main body part 2 may be resin layers having a glass transition temperature of not lower than 130° C. By using a resin layer having a glass transition temperature higher than or equal to this temperature, the heat resistance required for use in a vehicle can be secured. To satisfy this condition, the material of the base layers 6 and 8 may be, for example, a polycarbonate having a glass transition temperature of 150° C. For example, when the sheet laminate 1 is placed for 240 hours in an 80° C. atmosphere, using a polycarbonate as the material of the main body part 2 makes it possible to maintain a favorable state without any deformation or the like in the front surface 2a. On the other hand, when a resin having a glass transition temperature lower than 130° C. was used as the material of the main 2, the deformation of the front surface 2a during the same test was greater than in the case of a polycarbonate. For example, when an ABS resin having a glass transition temperature of from 80 to 125° C., an acrylic (PMMA) resin having a glass transition temperature of 90° C., or a PVC resin having a glass transition temperature of 87° C. was used, the deformation of the front surface 2a was large. When a PET resin having a glass transition temperature of 69° C. was used, the deformation of the front surface 2a was even larger. Note that as long as the resin layer has a glass transition temperature of not lower than 130° C., the material may be a resin other than a polycarbonate. The conditions described in this paragraph are not conditions essential to the sheet laminate 1, and these conditions need not be satisfied.

Before and after the affixing of the sheet laminate 1 to the bonded surface 50a, the surface roughness of the front surface 2a may be substantially the same. “Surface roughness to be substantially the same” means that since the main body part 2 is not subject to the effects of concavities and convexities in the bonded surface 50a serving as an underlayer, the surface roughness of the front surface 2a is unaffected. This characteristic is achieved by setting the bending rigidity of the sheet laminate from 1 to 0.1 to 23 N, 0.2 to 23 N, or 0.8 to 10 N. For example, when a thin film with a low bending rigidity is affixed to the bonded surface 50a, the surface roughness of the film also increases due to the effects of the uneven shape of the bonded surface 50a serving as an underlayer. The conditions described in this paragraph are not conditions required for the sheet laminate 1, and these conditions need not be satisfied.

The sharpness of the front surface 2a of the main body part 2 after the sheet laminate 1 is affixed to the bonded surface 50a may be set to not less than 0.5 or not less than 0.7, for example. Note that the sharpness of the front surface 2a of the main body part 2 can be measured as the sharpness before and after attaching the main body part 2 to a coated plate with a sharpness of 0.2 prepared by applying a paint for an external plate to a flat steel plate and firing the plate and affixing the main body part 2 to the bonded surface using a PGD-IV portable sharpness glossmeter (available from the Japan Color Research Institute). The conditions for setting the sharpness of the front surface 2a to the value described above after the sheet is affixed to the bonded surface 50a include the requirement that the material itself constituting the front surface 2a be adjusted and the requirement that the sheet laminate 1 have bending rigidity so that it is unaffected by the uneven shape of the bonded surface 50, as described above. For example, the base layer 6 of the main body part 2 is made of a polycarbonate and the thickness is set to 0.5 mm, while a polyurethane is used as the surface protecting layer 7. The sharpness of the front surface 2a after affixing is 0.9. Note that when a high-gloss blackout film is affixed to the bonded surface 50a, the sharpness is 0.2. The conditions described in this paragraph are not conditions essential to the sheet laminate 1, and these conditions need not be satisfied.

The front surface 2a of the main body part 2 may have high scratch resistance. That is, the surface 2a of the main body part 2 may have a restoring force so as to be resistant to scratching and return to the original state even when scratched at washing with a sponge or the like. For example, when the material of the base layer 6 of the main body part 2 and the base layer 8 of the sidewall parts 3 is a polycarbonate and the material of the surface protecting layer 7 of the main body part 2 and the surface protecting layer 9 of the sidewall parts 3 is a polyurethane, the scratch resistance described above can be achieved. The conditions described in this paragraph are not conditions essential to the sheet laminate 1, and these conditions need not be satisfied.

The pencil hardness of the front surface 2a of the main body part 2 may be high and may be greater than or equal to B, for example. The pencil hardness is measured in accordance with JIS K5600-5-4. For example, when the material of the surface protecting layer 7 of the main body part 2 and the surface protecting layer 9 of the sidewall parts 3 is a polyurethane, the transmission of a deforming force to the base layer serving as an underlayer can be suppressed when traced with a pencil. For example, the pencil hardness of a high-gloss blackout film is smaller than 4B. The conditions described in this paragraph are not conditions essential to the sheet laminate 1, and these conditions need not be satisfied.

The front surface 2a of the main body part 2 may have high weather resistance. For example, when the sheet laminate 1 is placed outdoors for two years, the surface gloss should be maintained at a level of not less than 80%. For example, when the material of the surface protecting layer 7 of the main body part 2 and the surface protecting layer 9 of the sidewall parts 3 is a polyurethane, high weather resistance can be achieved, and the surface gloss can be maintained at a level of 88% even when left outdoors for five years. The conditions described in this paragraph are not conditions essential to the sheet laminate 1, and these conditions need not be satisfied.

The rear surface 2b of the main body part 2 has higher roughness than the front surface 2a. For example, the roughness of the rear surface 2b of the main body part 2 is increased when the rear surface is subjected to matte finishing or embossing. The roughness can be indicated in terms of the arithmetic average roughness Ra, the average spacing Sm of concavities and convexities, or the like according to JIS. The roughness of the front surface 2a of the main body part 2 is theoretically such that Ra approaches zero and Sm approaches infinity. In contrast, the roughness of the rear surface 2b when subjected to matte finishing or embossing is such that Ra is not less than 1 μm or not less than 2 μm, for example, and Sm is not greater than 100 μm or not greater than 50 μm, for example. The conditions described in this paragraph are not conditions essential to the sheet laminate 1, and these conditions need not be satisfied.

The main body part 2 may be highly deformable by stamping to accommodate folding for forming the sidewall parts 3. That is, no cracks should be generated when the sidewall parts 3 are folded by stamping. For example, when the material of the surface protecting layer 7 of the main body part 2 and the surface protecting layer 9 of the sidewall parts 3 is a polyurethane, no cracks are generated due to stamping, but when the material is a PMMA resin, cracks are generated. In addition, the material of the surface protecting layers 7 and 9 may have elastic properties under temperature conditions at 80° C. For example, no cracks should be generated in the surface protecting layers 7 and 9 even after the sheet laminate 1, which is folded by stamping, is placed for 240 hours in an atmosphere at 80° C. The surface protecting layers 7 and 9 have a breaking elongation of not less than 100% at 80° C.

### Material of Each Constituent Element of the Sheet Laminate

The base layer 6 of the main body part 2 and the base layer 8 of the sidewall parts 3 are smooth, hard, and thick, and the material thereof may be a thermoplastic resin. That is, the main body part 2 and the sidewall parts 3 have a structure including a thermoplastic resin layer. A polycarbonate, unstretched PET, ABS, hard PVC, or a mixture thereof, for example, may be used as a thermoplastic resin. Alternatively, the base layers 6 and 8 may be formed by laminating a plurality of types of these materials. A polycarbonate or a mixture of a polycarbonate and another thermoplastic resin other than a polycarbonate is preferable in that the heat resistance is excellent. When the base layer is too thin, the shape retention after bending decreases, and the surface smoothness is lost due to concavities and convexities of the base material after affixing. When the base layer is too thick, bending becomes difficult. In addition, only a product with a large curvature of the outer surface side of the bent part can be produced, and the shape reproducibility is lost. Further, it becomes difficult to form a wound state which is advantageous for continuous processing. The thickness of the base layer may be from 0.2 to 2 mm, preferably from 0.3 to 2 mm, and more preferably from 0.5 to 1.5 mm.

The surface protecting layer 7 of the main body part 2 and the surface protecting layer 9 of the sidewall parts 3 may contain a polyurethane. That is, the main body part 2 contains a polyurethane layer as the surface protecting layer 7, and the sidewall parts 3 contain a polyurethane layer as the surface protecting layer 9. Examples of polyurethanes that can be used include products prepared by reacting a non-yellowing polyester polyol, glycol, a polycaprolactone polyol, a polycarbonate diol, an acryl polyol, or a mixture thereof with isophorone diisocyanate(IPDI), hydrogenated MDI (4,4′-cyclohexylmethane diisocyanate), hexamethylene diisocyanate (HDI), a polymer thereof or a mixture thereof. In addition, the material of the surface protecting layer 7 of the main body part 2 and the surface protecting layer 9 of the sidewall parts 3 may be a product prepared by crosslinking a non-yellowing aqueous polycarbonate polyurethane with polycarbodiimide, aziridine, or the like. Further, the surface protecting layer 7 of the main body part 2 and the surface protecting layer 9 of the sidewall parts 3 may be colored by adding a colorant such as carbon black to the resin described above. In this embodiment, the surface protecting layer 9 is colored black, but the color is not particularly limited to this color. The surface protecting layers 7 and 9 may also be formed by laminating a plurality of types of these materials. In addition, when used outdoors, the material of the surface protecting layer 9 may be selected considering weather resistance so that there is minimal change in color or gloss even when used outdoors for many years. The material of the surface protecting layer 9 preferably also has high elongation at break at a high temperature so that no cracks are formed even when exposed to a high-temperature environment at 80° C. after being stretched by folding. Examples of such a polyurethane composition include a polyurethane produced by a reaction between a polycaprolactone polyol and an IPDI isocyanate described in the example of JP 05-155976 A, a polyurethane produced by a reaction of three polymer components of a polycaprolactone diol, a polycarbonate diol, and an IPDI described in claim 1 of JP 2007-297569 A, a polyurethane produced by subjecting a polycarbonate diol, and a carboxyl group-containing aliphatic diol, and hydrogenated MDI to chain length extension and crosslinking the product with a polycarbodiimide described in claim 1 of WO 2013/173424. All of these have a performance with a gloss retention of not less than 80% and a color difference value of not greater than 3 in a typical accelerated weathering test (SWOM2000h Xenon 750 MJ) or after one year of exposure outdoors, and an elongation at break of not less than 100% (at least double the original length) in a tensile test in an atmosphere of 80° C. or 120° C. When the surface protecting layers 7 and 9 are too thin, the capacity to protect the underlayer such as the base layer from scratching, chemicals, and UV rays is reduced. When the surface protecting layers 7 and 9 are too thick, a local force at the time of bending is absorbed by deformation, and the shape reproducibility is reduced. The thickness of the surface protecting layers may be from 0.003 to 0.2 mm, preferably from 0.01 to 0.1 mm, and more preferably from 0.02 to 0.07 mm.

By providing a peelable application film such as a PET film on the front surface side of the surface protecting layers 7 and 9, deformation of the surface protecting layers, scratching, and contamination can be prevented at the time of folding, finishing, storage, and transportation. A biaxially stretched film is preferable as a PET film. An easily moldable PET film that can be more easily stretched at room temperature or a high temperature may also be used. By setting the gloss of the front surface of the PET film in contact with the surface protecting layers 7 and 9, the surface gloss of the surface protecting layer appearing after the gloss has been peeled away can be designed from a high gloss to a low gloss state. When the PET film is too thin, the capacity to prevent the deformation of the surface protecting layers 7 and 9 such as dents occurring at the time of bending, finishing, or transportation is reduced. When the PET film is too thick, local stretching is inhibited at the time of bending, and the shape reproducibility is reduced. The thickness of the PET film may be from 0.006 to 0.288 mm, preferably from 0.016 to 0.125 mm, and more preferably from 0.025 to 0.075 mm.

### Production Method

Next, an example of the production method of the sheet laminate 1 will be described. However, the method for producing the sheet laminate 1 is not limited to the method described below.

The method for producing the sheet laminate 1 includes: a preparing step of preparing a sheet member 100 including a front surface 2a serving as a design surface and a rear surface 2b (sheet preparing step); and a folding step of folding the ends of the sheet member 100 to form a pair of sidewall parts 3 extending toward the rear surface 2b side with respect to the main body part 2.

In the sheet preparing step, a sheet member 100 is prepared such that the entire surface of a base layer (layer corresponding to the base layers 6 and 8 after completion) is covered by a surface protecting layer (layer corresponding to the surface protecting layers 7 and 9 after completion). Specifically, the base layer is formed from a state in which the thermoplastic resin is melted at a higher temperature than the melting point to a prescribed thickness and size by the following methods. The methods include an extrusion method of extruding the thermoplastic resin from a gap of a certain thickness, or a calendar method of passing the thermoplastic resin between two rolls adjusted to a constant gap.

Prior to the lamination of the surface protecting layer, a plurality of layers of films may be attached to the surface of the base layer by providing a design, printing a shape, applying a coating layer, attaching a coloring film, or performing metal deposition. An additional layer may be provided by applying a primer or the like to enhance the adhesion or durability between layers.

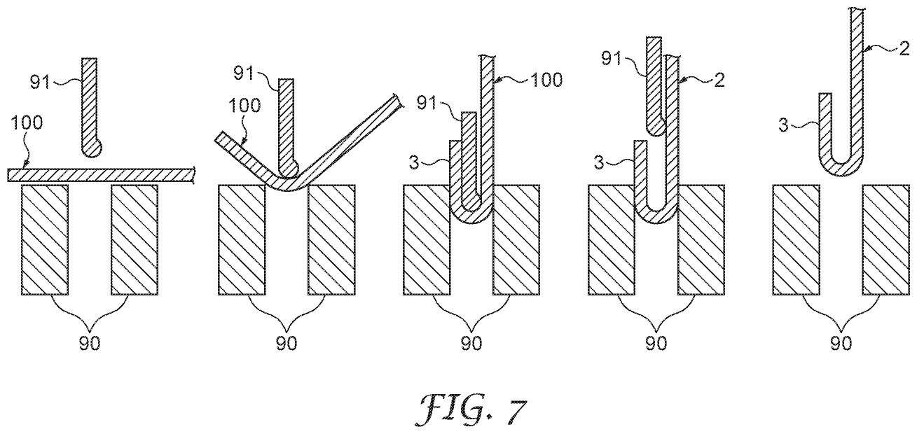

The folding step may be executed using mold pieces 90 and 91 illustrated in FIG. 7. As illustrated in FIG. 7, the folding step includes: preparing a pair of mold pieces 90 and 91; fixing the sheet member 100 to one mold piece 90 (FIG. 7A); and forming a curved shape with respect to the sheet member 100 by moving at least the one mold piece 90 or the other mold piece 91 in a relative manner (FIGS. 7B and 7C). In the step of forming a curved shape, sidewall parts 3 having a curved shape projecting outward with respect to the main body part 2 are formed by folding the ends of the sheet member 100 with the mold pieces 90 and 91 and applying heat to the folded portions. At this time, heat is preferably applied only to the parts corresponding to the sidewall parts 3.

One mold piece 90 has a groove part with mutually opposing parallel side surfaces, and the other mold piece 91 has a shape in which the sheet member 100 is wound and inserted into the groove part. Therefore, as the other mold piece 91 enters the groove part of the one mold piece 90, the sheet member 100 is folded into a substantially U-shape along the groove part (FIGS. 7B and 7C). At this time, the outer surfaces of the folded portions of the sheet member 100 are heated by warm air, infrared rays, water vapor, or the like from the opening of the mold piece 90 to reduce stress. Alternatively, heat may be applied to the folded portions by heating at least one of the mold piece 90 or the mold piece 91. In such a step, sidewall parts 3 having a curved shape are formed. After molding is complete, the mold piece 91 is released from the sidewall parts 3 (FIGS. 7D and 7E), and the sidewall parts 3 are released from the mold piece 90. Note that after one sidewall part 3 is formed, the sheet member 100 is inverted vertically, and the other sidewall part 3 is then formed with the same procedure as the method illustrated in FIG. 7.

### Affixing Method

As illustrated in FIGS. 6A and 6B, the affixing method will be described using a case in which the adherend is a B-pillar 50 of an automobile as an example. As illustrated in FIG. 6A, the side surfaces 50b of both sides near the upper end of the B-pillar 50 are respectively sandwiched by the sidewall parts 3 on both sides near edges 2f on the lower end side of the sheet laminate 1. Here, since the width dimension near the lower end of the sheet laminate 1 is set to be greater than the width dimension near the upper end of the B-pillar 50, the side surfaces 50b can be easily sandwiched by the sidewall parts 3. In this state, the sidewall parts 3 of the sheet laminate 1 are guided by the side surfaces 50b of the B-pillar 50 to lower the sheet laminate 1. As a result, the sheet laminate 1 is lowered while the sidewall parts 3 sequentially sandwich the side surfaces 50b near the upper end of the B-pillar 50. In a state in which the B-pillar 50 is covered by the sheet laminate 1, the sidewall parts 3 may not fit into the side surfaces 50b of the B-pillar 50 due to interference between the sash 52 and the sidewall parts 3 at the time of insertion near the sash 52 of the upper end of the B-pillar 50. In this case, the sidewall parts 3 may be fitted into the side surfaces 50b of the B-pillar 50 by pressing the sheet laminate 1 from the front. When the depth dimension L1 of the curved shape of the sidewall parts 3 in the region E1 near the upper end is short (see FIG. 3), this fitting becomes easy to implement.

### Operation/effect

The sheet laminate 1 according to this embodiment includes a pair of sidewall parts 3, each extending toward the rear surface 2b side from a pair of mutually opposing edges of the main body part 2. The pair of sidewall parts 3 have a curved shape projecting outward with respect to the main body part 2. Including such a sidewall part 3 makes it possible to affix the sheet laminate 1 to the B-pillar 50 by sandwiching the side surfaces 50b of both sides of the B-pillar 50 having a bonded surface 50a by using the curved shape of the pair of sidewall parts 3 while covering the bonded surface 50a with the design surface of the main body part 2. As a result, the sheet laminate 1 can be affixed easily to the bonded surface 50a, which enhances handleability of the sheet laminate 1.

Note that when a known extensible film is attached to the bonded surface 50a of the B-pillar 50, the extensible film needs to be attached while pulling and pressing with a tool after the film is positioned. In addition, when a garnish formed by injection molding or the like is used, the thickness is large, and thus the garnish cannot deform in conformance with the shape of the bonded surface 50a when attached to the B-pillar 50 with double-sided tape. Therefore, a garnish having the same shape as that of the bonded surface 50a of the B-pillar 50 needs to be produced. In addition, since the garnish is a rigid body having at least a certain thickness, which is heavy, there is a demand for a reduction in weight. In contrast, in the case of the sheet laminate 1 described above, the sheet laminate 1 can be affixed to the B-pillar 50 by simply sandwiching the side surfaces 50b of the B-pillar 50 with the sidewall parts 3. Note that since a known extensible film is too thin, sidewall parts 3 having a curved shape cannot be formed as in the sheet laminate 1 of this embodiment. Even when sidewall parts 3 could be formed, the shape retention of the sidewall parts 3 would be low, and the sheet laminate 1 would easily come loose when fitted into the B-pillar 50. In addition, since the garnish is a rigid body having a large thickness, the garnish cannot be deformed even when sidewall parts having a curved shape are formed, and thus the garnish cannot be fitted with the B-pillar 50. Further, due to the thickness of the garnish, a height difference arises in comparison to the window glass of an adjacent door when the garnish is affixed to the B-pillar 50. This is not preferable from the perspective of appearance.

The thickness of the main body part 2 may be from 0.3 to 2 mm. As a result, both the mountability of the sheet laminate 1 onto the B-pillar 50 and delamination resistance after mounting can be achieved.

The main body part 2 may include a polycarbonate layer. As a result, a main body part 2 which has both flexibility and rigidity can be formed. In addition, the sidewall parts 3 become easy to fold.

The main body part 2 may include a polyurethane layer as a surface protecting layer 7. As a result, the sidewall parts 3 become easy to fold.

The rear surface 2b may have a higher roughness than the front surface 2a. As a result, when the sheet laminate 1 is mounted on the B-pillar 50, the sliding of the rear surface 2b with respect to the bonded surface 50a can be improved, which enhances mountability.

The depth dimensions of the curved shape of the pair of sidewall parts 3 may be asymmetrical. As a result, the pair of sidewall parts 3 respectively have depth dimensions corresponding to the shape of the object.

The sidewall parts 3 have'a first region E1 on the upper end side and a second region E2 below the first region E1. In the first region E1, the depth dimension L1 of the curved shape along one edge may be shorter than the depth dimension L2 of the curved shape in the second region E2. For example, when a structure such as a sash 52 extending in the lateral direction is provided in near the upper end of the B-pillar 50, the sidewall parts 3 become difficult to fit into the side surfaces 50c of the B-pillar 50 due to interference between the structure and the sidewall parts 3 near the structure. Disposing the first region E1 having a short depth dimension L1 near the structure makes it possible to easily fit the sidewall parts 3 into the side surfaces 50b of the B-pillar 50 by pressing the vicinity of the first region E1 into the B-pillar 50.

The method for producing the sheet laminate 1 is a method for producing the sheet laminate 1 to be affixed to the bonded surface 50a of the B-pillar 50, the method including: a preparing step of preparing a sheet member 100 including a front surface 2a serving as a design surface and a rear surface 2b; and a folding step of folding the ends on both sides of the sheet member 100 to form a pair of sidewall parts 3 extending toward a rear surface 2b side with respect to a main body part 2; wherein in the folding step, the ends of the sheet member 100 are folded with mold pieces 90 and 91, and heat is applied to the folded portions to form sidewall parts 3 having a curved shape projecting outward with respect to the main body part 2.

With the method for producing the sheet laminate 1, a sheet laminate 1 exhibiting the same operation and effect as the sheet laminate 1 described above can be produced.

### MODIFIED EXAMPLE

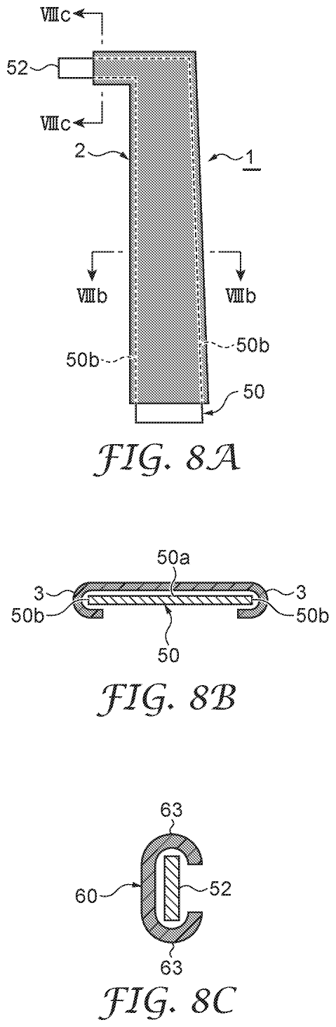

For example, in the embodiment described above, the sheet laminate 1 is a sheet which covers only the B-pillar 50 extending in the vertical direction, but the sheet laminate 1 may also have a portion which covers the sash 52. For example, as illustrated in FIG. 8A, the sheet laminate 1 includes an extension part 60 which extends toward one side in the lateral direction (direction in which the edges 2c oppose one another) at the upper end of the main body part 2 extending in the vertical direction. As illustrated in FIG. 8C, the extension part 60 includes sidewall parts 63 on the opposing edges in the vertical direction. The pair of sidewall parts 63 have a curved shape projecting in the vertical direction from the extension part 60. As a result, the curved shape of the sidewall parts 63 sandwiches the upper and lower side surfaces so that the extension part 60 can cover the sash 52.

In addition, the B-pillar (or an A-pillar or C-pillar) to which the sheet laminate 1 is to be affixed is merely an example of an object having a bonded surface, and any object may be used as long as the object requires the formation of a design surface. For example, a vehicle exterior part (bumper or mirror), a vehicle interior part (dashboard), a furniture part, an electric appliance part, or an architectural part to which the sheet is to be affixed may be used.

### EXAMPLES

The sheet laminate according to one aspect of the present disclosure will be described in detail hereinafter with reference to examples, but the structure of the sheet laminate is not limited to the examples described below.

### Relationship Between Rear Surface Roughness and Workability and Mountability

### Example 1

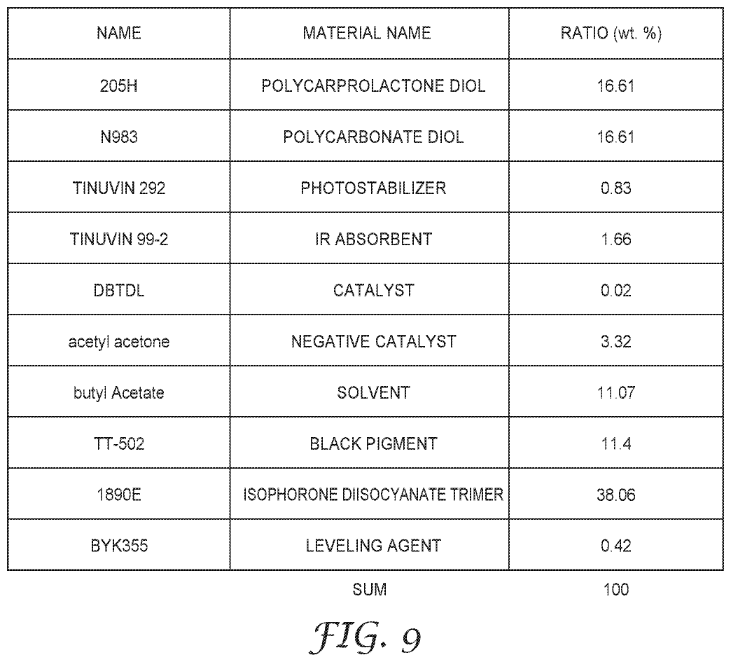

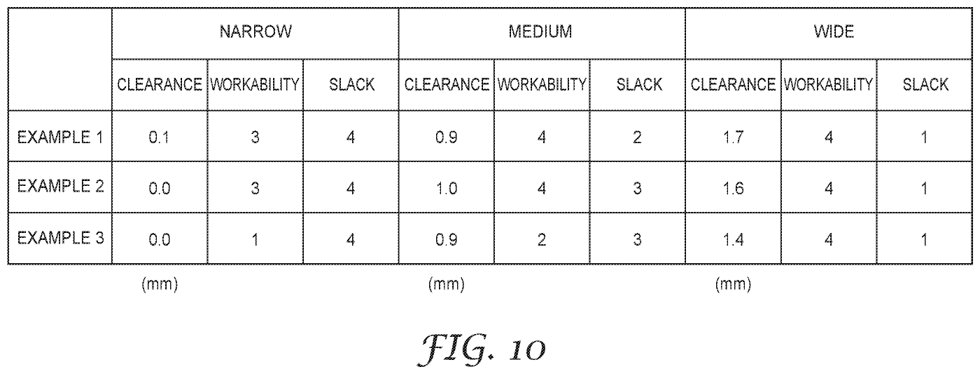

A polyurethane pre-solution that was colored black (see FIG. 9 for the composition) was applied by bar coating to one side of a polycarbonate sheet NP-4 available from Nippon Polyester Co., Ltd. having a thickness of 1.0 mm, and after the sample was placed in a hot air oven for five minutes at 60° C., an application film (biaxially stretched PET film T60 available from Toray having a thickness of 0.05 mm) was laminated with a roll laminator. When stored for one week at room temperature, the applied polyurethane pre-solution continued to undergo a polyurethane reaction until it became a black polyurethane layer (surface protecting layer) with no surface stickiness and a thickness of 0.05 mm, resulting in a state in which the PET film could also be peeled. The surface of the polycarbonate sheet was a glossy surface. The rear surface side of the polycarbonate sheet was subjected to matte finishing, and the arithmetic average roughness Ra was approximately 6±2 μm, while the average spacing Sm of concavities and convexities was approximately 26±4 μm. A sheet member with a three-layer structure and a thickness of 1.1 mm was prepared and cut into a trapezoidal shape having a greater width than the B-pillar. The mold pieces illustrated in FIG. 7 were then used to form sidewall parts having a curved shape on both edges of the main body part. Here, the temperature of the mold piece 91 was set to 165° C., the radius of curvature of the tip of the mold piece 91 was set to 1.25 mm, and the gap of the mold piece 90 was set to 4.1 mm. At this time, three types of sheet laminates—“narrow”, “medium”, and “wide”—were prepared so that there were three levels of clearance between the inner peripheral surfaces of the sidewall parts and the side surfaces of the B-pillar after affixing. The size of the clearance is illustrated in FIG. 10. A CR-V (RE3/4-type) pillar available from Honda Motor Co., Ltd. was prepared as a B-pillar. The workability when the sheet laminate of Example 1 was affixed to the B-pillar and the mountability after affixing were evaluated. The evaluation results are shown in FIG. 10. Note that workability was evaluated in four levels. Cases in which the sample was easily processed without requiring force for processing were evaluated as “4”; cases in which the force required for processing was not as small as “4” but the sample was easily processed were evaluated as “3”; cases in which the force required for processing was large were evaluated as “2”; and cases in which the force required for processing was large and the sample was difficult to process were evaluated as “1”. Mountability was evaluated in four levels by moving the affixed sheet laminate with the hand of the operator to confirm the state of slack. Cases with no slack were evaluated as “4”; cases with a small amount of slack were evaluated as “3”; cases with moderate slack were evaluated as “2”; and cases with a large amount of slack were evaluated as “1”.

### Example 2

This example was executed in the same manner as in Example 1 with the exception that a polycarbonate sheet NP-1 available from Nippon Polyester Co., Ltd. having a thickness of 1.0 mm was used as a polycarbonate sheet, that the rear surface was embossed, that Ra was approximately 50±5 μm, and that Sm was approximately 17±4 μm. The clearance, workability, and mountability of Example 2 are illustrated in FIG. 10.

### Example 3

This example was executed in the same manner as in Example 1 with the exception that a polycarbonate sheet EC105 available from Sumitomo Bakelite Co., Ltd. having a thickness of 1.0 mm was used as a polycarbonate sheet and that the rear surface was formed as a glossy surface in the same manner as the front surface. The clearance, workability, and mountability of Example 3 are illustrated in FIG. 10.

### Evaluation

In Example 1, in which the rear surface was subjected to matte finishing, and in Example 2, in which the rear surface was embossed, the workability was superior to Example 3, in which the rear surface was formed as a glossy surface, at each clearance level. Therefore, when the workability and mountability were evaluated comprehensively, it was confirmed that Examples 1 and 2 were superior to Example 3.

Depth dimension of curved shape on glass side

### Examples 4 to 8

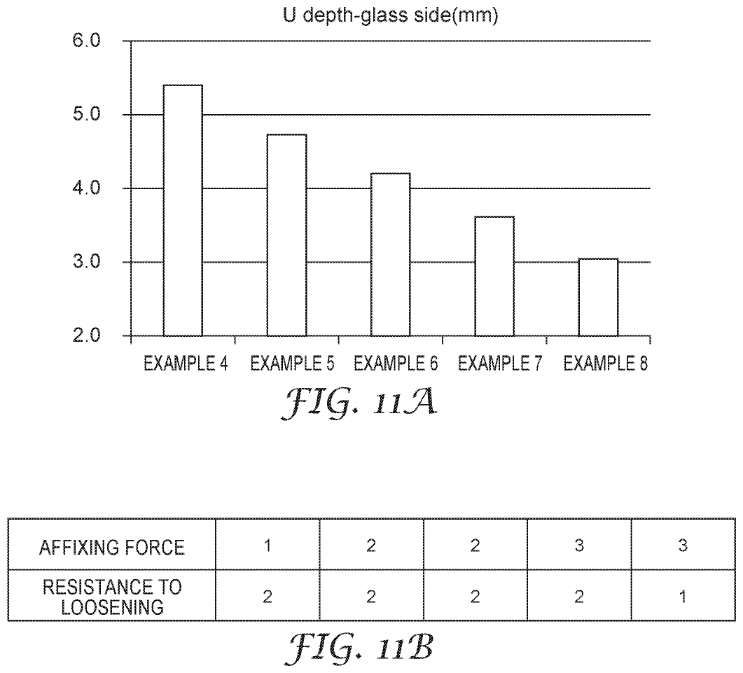

Sheet laminates prepared by varying the depth dimension of the sidewall part on the glass side of the sheet laminate of Example 3 described above (indicated by L in FIG. 2) were used as Examples 4 to 8. As illustrated in FIGS. 11A and 11B, a sheet laminate having the depth dimension of 5.4 mm was used as Example 4. A sheet laminate having the depth dimension of 4.8 was used as Example 5. A sheet laminate having the depth dimension of 4.2 was used as Example 6. A sheet laminate having the depth dimension of 3.6 was used as Example 7. A sheet laminate having the depth dimension of 3.1 was used as Example 8. The conditions regarding the dimensions of other portions of Examples 4 to 8 were the same as in Example 3. The depth dimension L of the sidewall part on the non-glass side in Examples 4 to 8 was 4.8 mm. The affixing force with respect to a B-pillar and the resistance to loosening after affixing were evaluated for Examples 4 to 8. The affixing force was measured as the force required at the time of affixing and was evaluated in three levels. Cases in which the affixing force was small were evaluated as “3”; cases in which the affixing force was large were evaluated as “2”; and cases in which the affixing force was very large were evaluated as “1”. Note that when the force was measured while pressing against the sample via a push-pull gauge, cases in which the affixing force was smaller than 5 kgf were evaluated as “3”. The resistance to loosening was evaluated in two levels taking into consideration the resistance to loosening when the operator removes the sheet laminate. Samples that were not removed were evaluated as “2”, and samples that were easily removed were evaluated as “1”. The results are illustrated in FIGS. 11A and 11B.

### Evaluation

In Examples 5 to 8, it was confirmed that the affixing force was small or not excessively large. On the other hand, in Examples 4 to 7, it was confirmed that resistance to loosening was established. The above results show that both mountability and resistance to loosening can be achieved by setting the depth dimension to 3.6 to 4.8 mm.

### Evaluation of Base Layer Thickness

### Examples 9 to 17

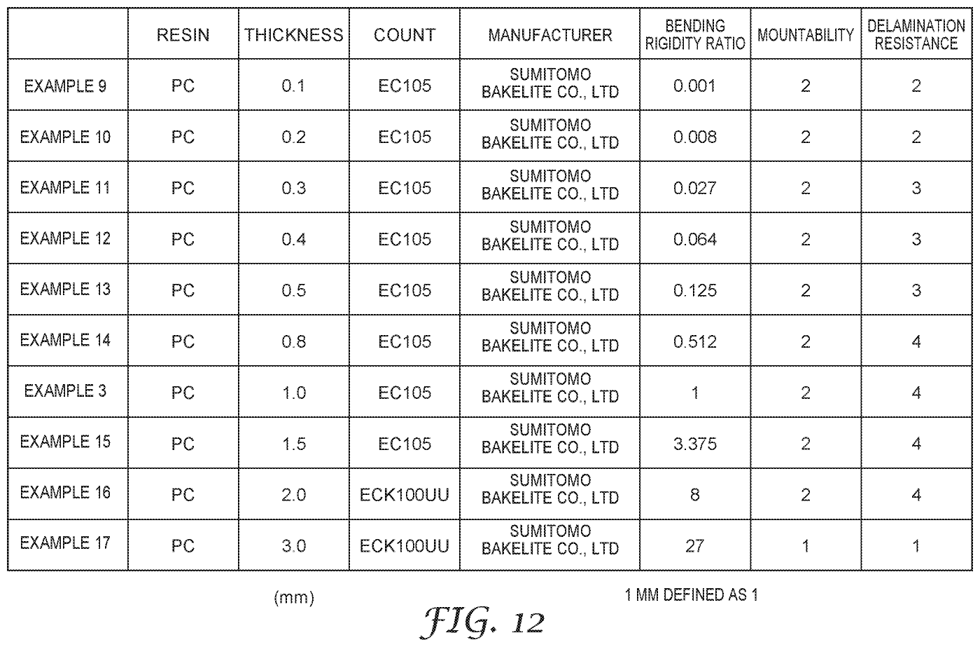

Sheet laminates prepared by varying the thickness of the polycarbonate sheet serving as a base layer of the sheet laminate of Example 3 described above within the range of from 0.1 to 3.0 mm, as illustrated in FIG. 12, were used as Examples 9 to 17. Note that in Examples 16 and 17, ECK100UU was used as a polycarbonate sheet. The bending rigidity of each example when the bending rigidity of Example 3 is defined as “1” is illustrated in FIG. 12. Mountability and delamination resistance were evaluated for Examples 3 and 9 to 17. Mountability was evaluated in two levels on the basis of whether the sheet laminate can be mounted by sandwiching the side surfaces of the B-pillar with the sidewall parts over the entire length of the sheet laminate when the sheet laminate was affixed using the method illustrated in FIGS. 6A and 6B. Cases in which the sheet laminate was mounted in a favorable state were evaluated as “2”, and cases in which the mounting state was poor were evaluated as “1”. Delamination resistance was evaluated in four levels on the basis of the difficulty to remove the affixed sheet laminate when the operator pulls the sheet laminate. Cases in which the sheet laminate was not removed even when pulled with any amount of force using both ands were evaluated as “4”; cases in which the sheet laminate was not removed when the upper end was grasped with the thumb and index finger and pulled, but the sheet laminate was removed when pulled so as to bend the sheet laminate using both hands were evaluated as “3”, and cases in which the sheet laminate was removed when the upper end was grasped with the thumb and index finger and pulled were evaluated as “2”. Samples evaluated as “1” for mountability were not tested and were evaluated as “1”. The results are illustrated in FIG. 12.

### Evaluation

Good results were achieved with regard to mountability for Examples 3 and 9 to 16. It was thus confirmed that a base layer having a thickness of not greater than 2.0 mm has good mountability. In addition, good results were achieved with regard to delamination resistance for Examples 3 and 11 to 15. It was thus confirmed that good delamination resistance is achieved by setting the base layer thickness to 0.3 to 2.0 mm.

### Evaluation of Base Layer Materials

### Examples 18 to 21

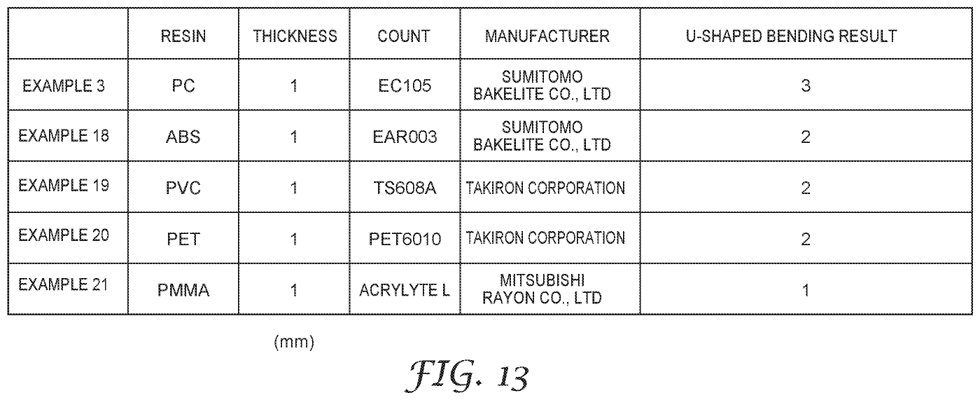

Sheet laminates prepared by varying the material of the base material of the sheet laminate of Example 3 described above to those illustrated in FIG. 13 were used as Examples 18 to 21. The processability when the curved shape of the sidewall parts was formed (U-shape bending) was evaluated for Examples 3 and 18 to 21. Processability was evaluated in three levels on the basis of the processability when U-shaped bending was performed by the method illustrated in FIG. 7. Cases in which U-shaped sidewall parts were formed in a favorable state at an angle close to 180° were evaluated as “3”; cases in which the angle was restored and the sheet laminate was not bent to a prescribed angle (however, a curved shape was formed) were evaluated as “2”; and cases in which parts were damaged during processing were evaluated as “1”. The results are illustrated in FIG. 13.

### Evaluation

Favorable processing was performed for Example 3. It was thus confirmed that good processability is achieved by using a polycarbonate as the base layer.

1. A sheet laminate to be affixed to a surface of an object, the sheet laminate including:
a main body part including a front surface serving as a design surface and a rear surface; and
a pair of sidewall parts, each extending toward the rear surface side from a pair of mutually opposing edges of the main body part;
wherein the pair of sidewall parts have a curved shape protruding outward with respect to the main body part, and the sheet laminate is sufficiently rigid so that the pair of sidewall parts retain their curved shape without being affixed to the surface of the object.

2. The sheet laminate according to claim 1, wherein a thickness of the main body part is from 0.3 to 2 mm.

3. The sheet laminate according to claim 1, wherein the main body part includes a polycarbonate layer.

4. The sheet laminate according to claim 1, wherein the main body part includes a polyurethane layer as a surface protecting layer.

5. The sheet laminate according to claim 1, wherein the rear surface has a higher roughness than the front surface.

6. The sheet laminate according to claim 1, wherein depth dimensions of the curved shape of the pair of sidewall parts is asymmetrical.

7. The sheet laminate according to claim 1, wherein
the sidewall parts each have a first region on an upper end side and a second region below the first region, and
in the first region, the depth dimension of the curved shape along one edge is shorter than the depth dimension of the curved shape in the second region.

8. The sheet laminate according to claim 1, wherein the sheet laminate has a bending rigidity in the range of from 0.1 to 23 N.

9. The sheet laminate according to claim 1, wherein the main body part includes a base layer and a surface protection layer laminated on the base layer, with the surface protecting layer including a front surface serving as the design surface.

10. The sheet laminate according to claim 1, wherein the main body part and the sidewall parts have a structure that includes a thermoplastic resin.

11. A method for producing a sheet laminate to be affixed to a surface of an object, the method comprising:
preparing a sheet member having a front surface serving as a design surface and a rear surface; and
folding the ends on both sides of the sheet member to form a pair of sidewall parts extending toward a rear surface side with respect to a main body part;
wherein in the folding step, the ends of the sheet member are folded with a mold piece and heat is applied to the folded portions to form the sidewall parts having a curved shape projecting outward with respect to the main body part, and the sheet laminate is sufficiently rigid so that the pair of sidewall parts retain their curved shape without being affixed to the surface of the object.

12. The sheet laminate according to claim 1, wherein the sheet laminate has a 2% tensile strength of not less than 20 N/10 mm of width.

13. The sheet laminate according to claim 8, wherein the sheet laminate has a 2% tensile strength of not less than 20 N/10 mm of width.

14. The sheet laminate according to claim 1, wherein the sheet laminate includes a design surface and is operatively adapted for being affixed to and decorate a surface of a vehicle part, electrical part or an architectural part.

15. The method according to claim 11, wherein the sheet laminate has a bending rigidity in the range of from 0.1 to 23 N.

16. The method according to claim 11, wherein the sheet laminate has a 2% tensile strength of not less than 20 N/10 mm of width.

17. The method according to claim 15, wherein the sheet laminate has a 2% tensile strength of not less than 20 N/10 mm of width.

18. The method according to claim 11, wherein the object is a vehicle part, electrical part or an architectural part, the sheet laminate includes a design surface, and the sheet laminate is operatively adapted for being affixed to and decorate the surface of the object.

19. A method of decorating a surface of an object, said method comprising:
producing a sheet laminate according to claim 1; and
affixing the sheet laminate to the surface of the object.

20. The method according to claim 19, wherein the object is a vehicle part, electrical part or an architectural part, the sheet laminate includes a design surface, and the sheet laminate is operatively adapted for being affixed to and decorate the surface of the object.
